(19) United States
(12) Patent Application Publication
(10) Pub. No.: US 2010/0119216 A1
(43) Pub. Date: May 13, 2010

(54) BROADCAST DATA RECORDING AND REPRODUCING METHOD AND APPARATUS FOR MOBILE TERMINAL

(76) Inventor: Kwang Jeung Lee, Suwon-si (KR)

Correspondence Address: CHA & REITER, LLC, 210 ROUTE 4 EAST STE 103, PARAMUS, NJ, 07652, US

(21) Appl. No.: 12/542,930

(22) Filed: Aug. 18, 2009

(30) Foreign Application Priority Data
Nov. 12, 2008 (KR) 10-2008-0112400

(51) Int. Cl. H04N 7/26

(52) U.S. Cl. 386/124

(57) ABSTRACT

A broadcast data recording and reproducing method and apparatus for a mobile terminal is provided for improving digital broadcast playback performance of the mobile terminal by decoding broadcast data using the Packet Identifiers (PID's) stored while recording the broadcast data. A recorded broadcast data playback method for a mobile terminal detects a playback instruction for playing recorded broadcast data; determines whether a resume marker exists in the recorded broadcast data; obtains, when a resume marker exists, a resume time for determining a playback start time of the recorded broadcast data; extracts a system time of the recorded broadcast data corresponding to the obtained resume time; acquires a plurality of packet identifiers corresponding to the system time; decodes the recorded broadcast data indicated by the acquired packet identifier and plays the decoded recorded broadcast data.

### CLAIM OF PRIORITY

This application claims the benefit of the earlier filing date, pursuant to 35 USC 119, to that patent application entitled “BROADCAST DATA RECORDING AND REPRODUCING METHOD AND APPARATUS FOR MOBILE TERMINAL” filed in the Korean Intellectual Property Office on Nov. 12, 2008 and assigned Serial No. 10-2008-0112400, the contents of which are 10 incorporated herein by reference.

### BACKGROUND OF THE INVENTION

1. Field of the Invention

The present invention relates to a mobile terminal and, in particular, to a broadcast data recording and reproducing method and apparatus for a mobile terminal that is capable of improving digital broadcast playback performance of the mobile terminal by decoding broadcast data using previously stored Packet Identifiers (PID's).

2. Description of the Related Art

Digital broadcast playback is one of the most popular functions of the latest generation mobile terminals. A broadcast-enabled mobile terminal has a capability to demodulate and decode a digitally encoded and modulated broadcast signal in a specific digital broadcast format.

There are several mobile digital broadcast formats including Digital Multimedia Broadcasting (DMB), Digital Video Broadcasting-Handheld (DVB-H), Integrated Service Digital Broadcasting-Terrestrial (ISDB-T) and MediaFlO. In the mobile digital broadcast systems, the broadcast data are broadcasted in the form of a packet stream. In order for the mobile terminal to receive and play the broadcast data, the mobile terminal has to extract the packet identifier (PID) from a Program Map Table (PMT) acquired from the broadcast data. That is, the mobile terminal acquires the video packet identifier, audio packet identifier, and data packet identifier and decodes the Packetized Elementary Streams (PES's) based on the identifiers. However, when playing back the recorded broadcast data, the mobile terminal cannot decode the broadcast data received with the packets before acquiring the PMT normally, since there is no PID's of those packets.

Accordingly, the packets received before acquiring the PMT from the broadcast data are useless and, thus, occupies the memory space of the mobile terminal unnecessarily especially when recoding the broadcast data.

### SUMMARY OF THE INVENTION

In order to overcome the problem of the prior art, the present invention provides a broadcast data recording and reproducing method and apparatus for a broadcast-enabled mobile terminal that is capable of avoiding waste of memory space by storing the broadcast data with the PID's referred from the PMT.

Also, the present invention provides a broadcast data recording and reproducing method and apparatus for a broadcast-enabled mobile terminal that is capable of reducing playback start delay of recorded broadcast data by storing time information together with the chanced PID's, when the PID's are changed while recording the broadcast data.

In accordance with an exemplary embodiment of the present invention, a method for playing recorded broadcast data in a mobile terminal includes detecting a playback instruction for playing recorded broadcast data; determining whether a resume marker exists in the recorded broadcast data; obtaining, when a resume marker exists, a resume time for determining a playback start time of the recorded broadcast data; extracting a system time of the recorded broadcast data corresponding to the obtained resume time; acquiring a plurality of packet identifiers corresponding to the system time; and decoding the recorded broadcast data indicated by the acquired packet identifier.

In accordance with another exemplary embodiment of the present invention, a broadcast data recording method for a mobile terminal includes playing broadcast data received in real time; acquiring Program Map Tables (PMT's) from the broadcast data; extracting packet identifiers from the PMT's; starting the recording of the broadcast data in response to a recording instruction input by a user; and storing the packet identifiers and system times at which the packet identifiers are extracted.

In accordance with another exemplary embodiment of the present invention, a broadcast data recording and reproducing apparatus for a mobile terminal includes a storage unit which stores packet identifiers extracted from broadcast data and system times; and a control unit which obtains, when a resume marker exists, a resume time pointed to by the resume marker in response to a recorded broadcast data playback instruction, extracts a plurality of packet identifiers stored in correspondence with the resume time, and plays the recorded broadcast data using the packet identifiers.

### BRIEF DESCRIPTION OF THE DRAWINGS

The above features and advantages of the present invention will be more apparent from the following detailed description in conjunction with the accompanying drawings, in which:

FIG. 1 is a schematic block diagram illustrating a configuration of a mobile terminal according to an exemplary embodiment of the present invention;

FIG. 2 is a flowchart illustrating a method for recording and reproducing broadcast data according to an exemplary embodiment of the present invention;

FIG. 3 is a flowchart illustrating a broadcast data recording procedure of a broadcast data playback method for a mobile terminal according to an exemplary embodiment of the present invention;

FIGS. 4a to 4c represent tables illustrating exemplary packet identifier information for used in the broadcast data recording method according to an exemplary embodiment of the present invention;

FIG. 5 is a flowchart illustrating a recorded broadcast data playback procedure of a broadcast data playback method for a mobile terminal according to an exemplary embodiment of the present invention; and

FIG. 6 is a conceptual diagram illustrating the recorded broadcast data playback timing in the broadcast data playback method of FIG. 5.

### DETAILED DESCRIPTION OF THE INVENTION

Exemplary embodiments of the present invention are described with reference to the accompanying drawings in detail. For the purposes of clarity and simplicity, detailed descriptions of well-known functions and structures incorporated herein may be omitted to avoid obscuring the subject matter of the present invention. Further, note that the same reference numbers are used throughout the drawings to refer to the same or like parts.

In an exemplary embodiment of the present invention, the term “system time” denotes a time recorded when the broadcast data recording is initially started or the PMT is changed during the recording. Here, the system time can be used for determining the playback restart time of the recorded broadcast data when a resume marker is used. The resume marker is a time point at which the recorded broadcast data playback is paused.

In an exemplary embodiment of the present invention, the term “resume time” denotes a time point at which the recorded broadcast data playback is paused. The resume time is acquired by extracting the system time using the conditional expression of equation 1, which is described in detail later. The resume time can be expressed by means of the resume marker.

In an exemplary embodiment of the present invention, the mobile terminal can be one of a Personal Digital Assistant (PDA), a Smartphone, a dedicated digital broadcast receiver, and a mobile phone including Code Division Multiple Access (CDMA) terminal, Wideband CDMA (WCDMA) terminal, Global System for Mobile communications (GSM) terminal, Universal Mobile Telecommunication System (UMTS) terminal, and their equivalent devices that support recording and reproducing digital broadcast data.

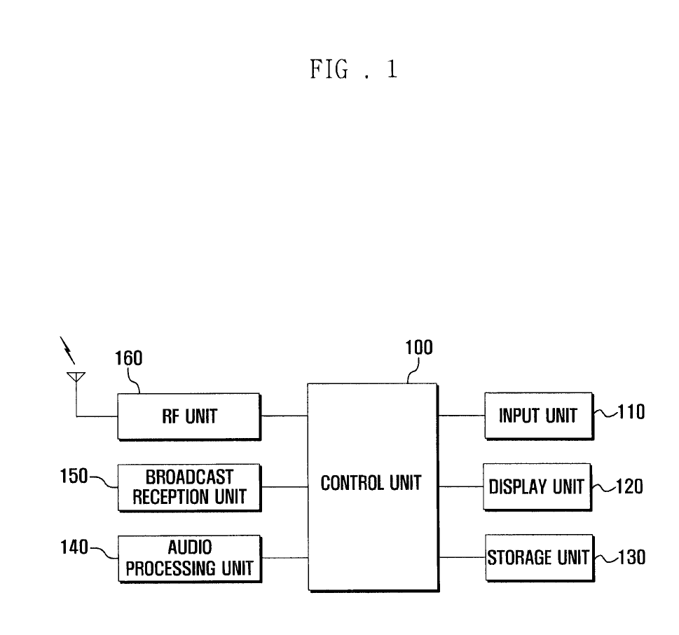

FIG. 1 is a schematic block diagram illustrating a configuration of a mobile terminal according to an embodiment of the present invention.

As shown in FIG. 1, the mobile terminal according to the embodiment of the present invention includes a control unit 100, an input unit 110, a display unit 120, a storage unit 130, an audio processing unit 140, a broadcast reception unit 150, and a Radio Frequency (RF) unit 160.

The input unit 110 is provided with a plurality of alphanumeric keys for receiving alphabetic and numeric information and a plurality of function keys for setting and executing the functions of the mobile terminal. The function keys can be implemented in the form of navigation keys, side keys, and shortcut keys. The input unit 110 generates key data in response to keystrokes and sends the key data to the control unit 100. Particularly in an exemplary embodiment of the present invention, the input unit 110 is configured to generate and send a key command for recording broadcast data while the mobile terminal playing the broadcast data. In more detail, the input unit 110 generates a key command for recording the broadcast data in real time, a key command for selecting a program, and a key command for playing the recorded broadcast data. These key commands are sent to the control unit 100.

The display unit 120 displays various screen images generated in association with the operations of the mobile terminal. For instance, the display unit 120 provides a visual interface to create a broadcast data playback screen image, an idle mode screen image, and various menu screen images. The display unit 120 can be implemented with a Liquid Crystal Display (LCD). In this case, the display unit 120 can be an LCD controller, a video data memory, and a plurality of LCD devices. In case when the LCD supports touchscreen functionality, the display unit 120 can act as a part of the input unit 110. Particularly in an exemplary embodiment of the present invention, the display unit 120 can be configured to display the broadcast data decoded from the broadcast signal received by means of the broadcast reception unit 150. The display unit 12 can display the video data of the recorded broadcast data with the resume marker function under the control of the control unit 100. The display unit 120 also can provide a control interface for controlling the recording of the broadcast data.

The storage unit 130 stores application programs associated with the digital broadcast playback function according to an exemplary embodiment of the present invention. The storage unit 130 also provides a buffer for buffering the broadcast signals. The storage unit 130 can include a program region and a data region.

The program region stores an operating system (OS) for booting up the mobile terminal and application programs including a broadcast data reception application, a broadcast data recording application, a PID backup application for storing the PID's extracted from the PMT while recording the broadcast data, a system time recording application for recording the system time point at which the PMT is changed, and a resume marker application for checking the resume marker while playing the recorded broadcast data. The program region also loads the application programs in response to the user request under the control of the control unit 100.

The data region stores the application data generated while the application programs are running in the mobile terminal. Particularly in an exemplary embodiment of the present invention, the data region stores the broadcast signal and broadcast data received by means of the broadcast reception unit 150. The data region also stores the data associated with one or more supplementary functions of the mobile terminal such as phonebook data, audio data, other user data and metadata of the data. The data region also stores the PID's extracted while recording the broadcast data. The PID's includes video PID's, audio PID's, and data PID's and stores them in the form of a table. The data region also stores the time points at which the broadcast data recording is initialized and the PMT is changed during the broadcast data recording.

The audio processing unit 140 includes a speaker (SPK) for outputting the audio data received by means of the broadcast reception unit 150 and a microphone (MIC) for inputting audio signal including voice and other sound. Particularly in an exemplary embodiment of the present invention, the audio processing unit 140 can be configured to output an alert sound for alerting the start of the broadcast data recording. The audio processing unit 140 also can process the audio data extracted from the recorded broadcast data.

The broadcast reception unit 150 receives the broadcast data corresponding to a program selected by the user under the control of the control unit 100. Particularly in an exemplary embodiment of the present invention, the broadcast reception unit 150 is provided with a receiver module (not shown) for receiving the broadcast signals transmitted by a broadcast station. In operation, the broadcast reception module 150 receives the broadcast signals transmitted by the broadcast station and sends the received broadcast signal to the control unit 100. The receiver module is a device configured to process the broadcast signal format of the broadcast station. For instance, when the broadcast station transmits the broadcast signal in a DMB format, the broadcast reception unit 150 is preferably implemented with a DMB receiver module for receiving the broadcast signals normally. In case that the broadcast station transmits the broadcast signals in DVB-H format, the broadcast reception unit 150 should be implemented with a DVB-H receiver module for receiving the broadcast signals normally. In the DMB and DVB-H systems, the broadcast data are transmitted in the form of packet streams and each packet is composed of a header and a payload. The packet header includes PID that is used for packet synchronization and channel identification.

The RF unit 160 is responsible for establishing a radio communication channel with a base station for voice and data such that the mobile terminal communicates with another terminal attached to the base station or other network. The RF unit 160 can be configured to be maintained in an activate state while the mobile terminal receives the broadcast signal and such that, when an incoming call or message is detected, the control unit 100 processes the incoming call or message prior to the broadcast signal. The RF unit 160 can be composed of an RF transmitter for up-converting and amplifying the frequency of the transmission signal and an RF receiver for low-noise amplifying and down-converting the frequency of the received signal.

The control unit 100 controls general operations of the mobile terminal and signaling among the internal function blocks of the mobile terminal. Particularly in an exemplary embodiment of the present invention, the control unit 100 extracts Program Specific Information (PSI) from the broadcast signal received by means of the broadcast reception unit 150. Here, the PSI includes a Program Association Table (PAT). The PAT includes the PMT information. The PMT information includes PID information.

The control unit 100 executes a broadcast data reception application in response to a user instruction input through the input unit 110 and displays the video data of the broadcast data received by means of the broadcast reception unit 150 on the display unit 120. If a broadcast playback instruction is input through the input unit 110, the control unit 100 acquires the PMT from the received broadcast data and extracts the packet data identifier information associated with the program from the PMT. The packet data identifier information includes at least one of a video packet identifier, an audio packet identifier, and a data packet identifier.

When a broadcast data recording instruction is input during the video data playback, the control unit 100 starts recording the broadcast data. During the broadcast data recording, the control unit 100 performs backup on the packet identifier information extracted from the PMT. The packet identifier information can be extracted from the PMT acquired while playing the broadcast data. At this time, the control unit 100 checks the current system time and stores the information on current system time within the storage unit 130 together with the packet identifier information extracted from the PMT.

The control unit 100 compares the PMT's acquired from the broadcast data that are received and recorded and monitors to detect a change of the PMT. If a PMT change is detected, the control unit 100 extracts the PID's of the changed PMT and checks the current system time. The system time can be a local time of the mobile terminal and represents a time point at which the broadcast data recording starts or a PMT change is detected or when the resume marker function is used in playback of the recorded broadcast data. The resume marker function is used for extracting the system time corresponding to the resume time of the playback of the recorded broadcast data and decoding the recorded broadcast data from the resume time with reference to the packet identifier information.

The control unit 100 can control the processing such the recorded broadcast data can be paused and then played from the paused time point. If a user instruction for playing the recorded broadcast data is detected, the control unit 100 determines whether a resume marker is set. When the resume marker function is initialized, the control unit 100 retrieves the packet identifier information corresponding to the initial system time from the back recorded broadcast data for playing the recorded broadcast data from the start point. When a resume marker is set, the control unit 100 retrieves the packet identifier information of the system time corresponding to the value satisfying a conditional expression for playing the recorded broadcast data from the time marked with the resume marker.

In an exemplary embodiment of the present invention, the conditional expression for the resume time can be expressed as shown in equation (1).

((Time N−1)−Time 1≦resume time<(Time N)−Time 1), (1)

where N is a number of PMT backup times during the broadcast data recording,
Time N is the system time for N^{th} PMT backup,
Time N−1 is the system time for (N−1)^{th} PMT backup, and
Time 1 is a system time at which the broadcast recording starts.

For instance, the control unit 100 can set the resume time for starting the resume marker function to 7000 ms, the system time for (N−1)^{th} PMT backup to 105789 ms, the system time for N^{th} PMT backup to 109865 ms, and the system time for the start of recording the broadcast data to 100000 ms. Here, the control unit 100 can start playing the recorded broadcast data corresponding to the packet identifier information at the (N−1)^{th} PMT backup prior to the resume time.

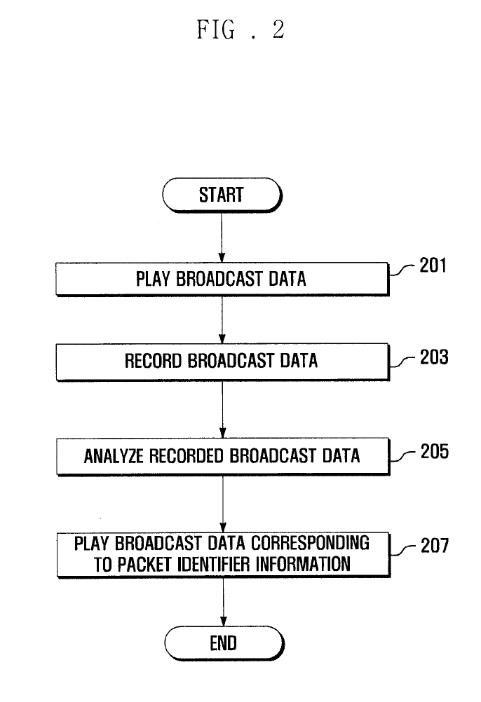

FIG. 2 is a flowchart illustrating a method for recording and reproducing broadcast data according to an exemplary embodiment of the present invention.

Referring to FIG. 2, the control unit 100 plays the broadcast data received by means of the broadcast reception unit 150 in response to a user instruction (201). The broadcast data received through the broadcast reception unit 150 includes the Program Association Table (PAT). The PAT includes the Program Map Table (PMT) information. The PMT information includes packet identifiers (PID's).

While playing the broadcast data, the control unit 100 monitors the input unit for the detection of a user instruction. If a broadcast data recording instruction is detected, the control unit 100 starts recording the broadcast data (203). At this time, the control unit 100 stores the packet identifier information included in the PMT of the broadcast data that are currently playing together with the current system time. The control unit 100 extracts the video PID, audio PID, and data PID from the packet identifier information of the PMT and stores the PID's in the form of a table together with the system time.

If a recorded broadcast data playback instruction is detected, the control unit 100 analyzes the recorded broadcast data recorded (205). At this time, the control unit 100 can check the resume time for executing the resume marker function. Next, the control unit 100 determines the playback start time of the recorded broadcast data and the system time corresponding to the resume time.

If the system time for playing the recorded broadcast data is available, the control unit 100 acquires the packet identifier information corresponding to the system time and starts decoding to play the recorded broadcast data corresponding to the packet identifier information (S207).

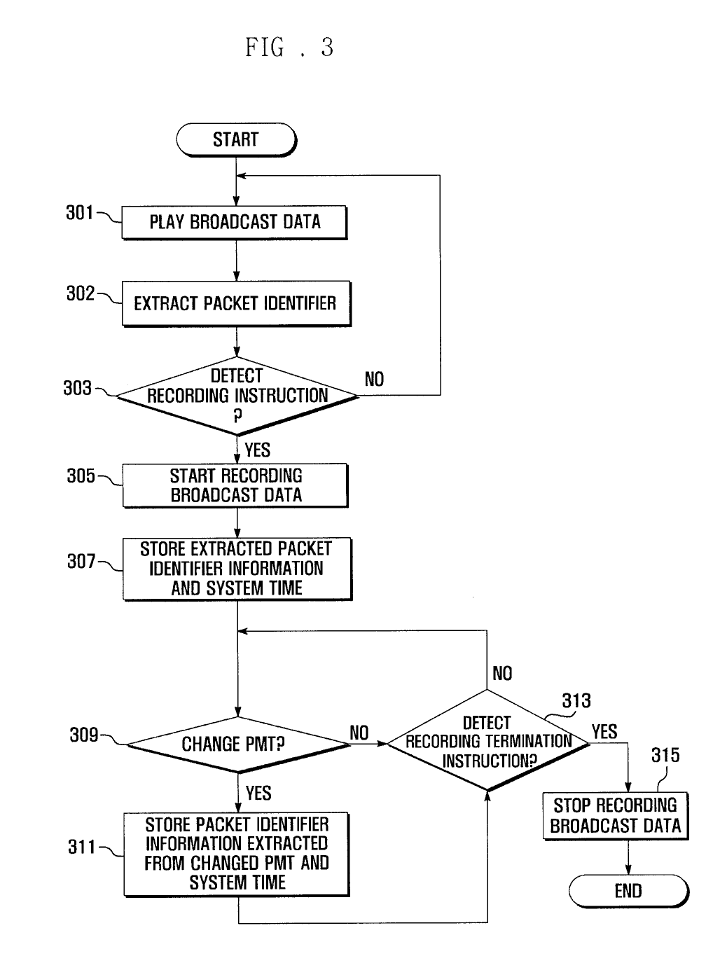

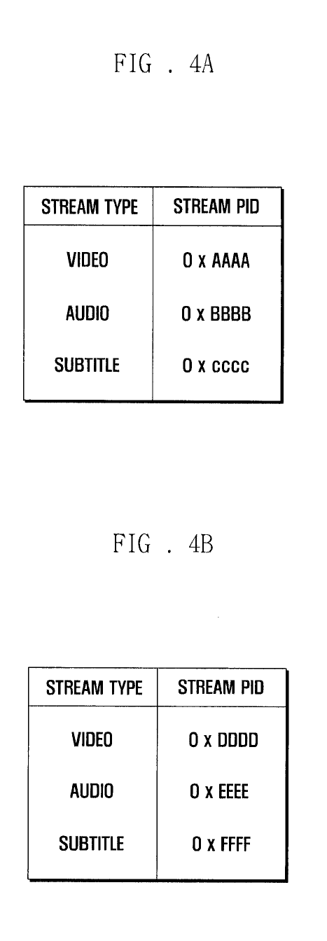

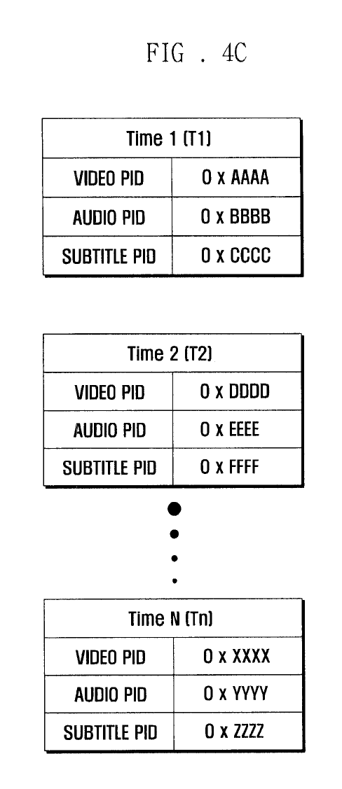

FIG. 3 is a flowchart illustrating a broadcast data recording procedure of a mobile terminal according to an exemplary embodiment of the present invention, and FIGS. 4a to 4c are tables illustrating exemplary packet identifier information used in the broadcast data recording method according to an exemplary embodiment of the present invention.

Referring to FIGS. 3 and 4a to 4c, the control unit 100 displays the video data of the broadcast data received by means of the broadcast reception unit 150 in response to a broadcast data playback instruction input by the user (301).

While playing the broadcast data, the control unit 100 checks the PMT included in the broadcast data and extracts the packet identifier information from the PMT (302).

Next, the control unit 100 monitors the input unit for detecting a user instruction and, if a user instruction is input, determines whether the user instruction is a broadcast data recording instruction (303).

If a broadcast data recording instruction is detected, the control unit 100 starts recording the broadcast data that are currently playing (305). At this time, the broadcast data recording instruction is input by the user pushing a function key assigned for the broadcast data recording. When no broadcast data recording instruction is input, the control unit 100 keeps playing the broadcast data received through the broadcast reception unit 150 in real time.

Once the broadcast data recording starts, the control unit 100 stores the packet identifier information including the video PID, the audio PID, and the data PID in the storage unit 130 together with the system time in the form of a table (307). Here, the system time is the mobile terminal's local time at which the broadcast data recording starts. For instance, the control unit 100 stores the packet identifier information extracted from the PMT acquired from the broadcast data in the form of a table as shown in FIG. 4a. In an exemplary packet identifier information table of FIG. 4a, the packet data identifier information includes a video PID “0xAAAA”, an audio PID “0xBBBB”, and a data PID “0xCCCC”.

After storing the extracted packet identifier information and the system time, the control unit 100 compares the PMT extracted from the currently received broadcast data and the PMT extracted from the previously received broadcast data repeatedly and determines whether the PMT has changed (309).

When the change of the PMT is detected, the control unit 100 extracts the packet identifier information from the changed PMT and stores the extracted packet identifier information and the system time at which the PMT change is detected in the storage unit 130 at step 311. For instance, the control unit 100 stores the packet identifier information extracted from the changed PMT acquired from the broadcast data in the form of a table as shown in FIG. 4b. In an exemplary packet identifier information table of FIG. 4b, the packet identifier information extracted from the change PMT includes a video PID “0xDDDD”, an audio PID “0xEEEE”, and a data PID “0xFFFF”. When the broadcast data recording starts, the control unit 100 stores the system time T1 (Time 1) indicating the time point at which the broadcast data recording starts together with the packet identifier information acquired from the PMT as shown in FIG. 4c.

If the PMT is changed while recording the broadcast data, the control unit 100 extracts the packet identifier information from the changed PMT and stores the extracted packet identifier information together with the system T2(Time 2) at which the PMT is changed. The control unit 100 can repeat the PMT change inspection until the broadcast data recording is terminated. The control unit 100 extracts the packet identifier information from the changed PMT and stores the extracted packet identifier information together with the system time Tn (Time N) at which the PMT is changed finally.

Whenever the packet identifier information and the system time are stored, the control unit 100 determines whether a broadcast data recording termination instruction is input (313).

If no broadcast data recording termination instruction is detected, the process goes to step 309.

Otherwise, if a broadcast data recording termination instruction is detected at step 313, the control unit 100 stops recording the broadcast data (315).

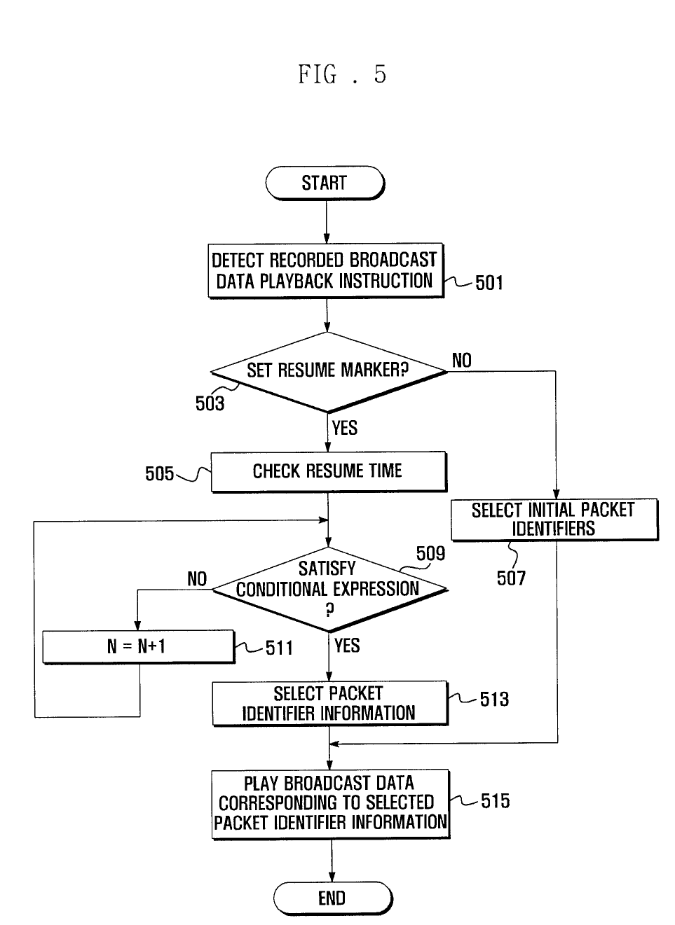

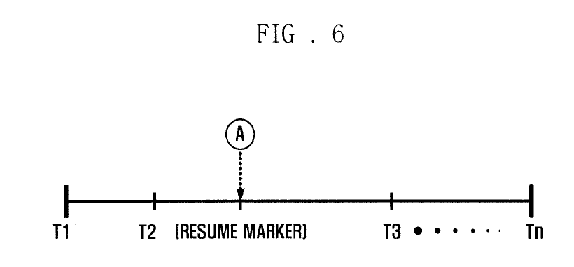

FIG. 5 is a flowchart illustrating a recorded broadcast data playback procedure of a broadcast data playback method for a mobile terminal according to an exemplary embodiment of the present invention, and FIG. 6 is a conceptual diagram illustrating the recorded broadcast data playback timing in the broadcast data playback method of FIG. 5.

Referring to FIGS. 5 and 6, the control unit 100 detects a recorded broadcast data playback instruction input by the user (501). If a recorded broadcast data playback instruction is detected, the control unit 100 determines whether a resume marker is set with the recorded broadcast data (503).

If a resume marker is not set with the recorded broadcast, the control unit 100 selects the initial packet identifier information acquired when the broadcast data playback started (507). At this time, the control unit 100 recognizes that the recorded broadcast data playback is requested to start from the initial recording start time. Otherwise, if a resume marker is set with the recorded broadcast data, the control unit 100 checks the resume time at which the resume marker is pointing (505). Here, the resume time is a time point at which the recorded broadcast data playback was paused. At this time, the control unit 100 can check the system time with reference to the resume time for acquiring the playback elapsed time of the recorded broadcast data.

Next, the control unit 100 determines whether the resume time satisfies the conditional expression (509). At this time, the control unit 100 may check the packet identifier information appropriate for the recorded broadcast data depending on the system time.

In an exemplary embodiment of the present invention the conditional expression can be expressed as equation (1).

((Time N-1)−Time 1≦resume time<(Time N)−Time 1), (1)
where N is a number of PMT backup times during the broadcast data recording,
   Time N is the system time for N^{th} PMT backup,
   Time N−1 is the system time for (N−1)^{th} PMT backup, and
   Time 1 is a system time at which the broadcast recording starts.

The control unit 100 determines the system time corresponding to the resume time according to the conditional expression. If the resume time does not satisfy the conditional expression, the control unit 100 increments the value N, which denotes the number of system PMT back times, by 1 (511) and repeats the determination process. In this manner, the control unit 100 can find a system time which is prior to the resume time. If the resume time satisfies the conditional expression at step 509, the control unit 100 selects the packet identifier information corresponding to the system time (513). For instance, when a resume marker is set with the recorded broadcast data, the control unit 100 checks the resume time A for executing the resume marker function as shown in FIG. 6. The control unit 100 applies the resume time to the conditional expression to acquire the system time satisfying the conditional expression. In this case, the control unit 100 acquires the packet identifier information stored in correspondence with the system time T2 at which the PMT is first changed while recording the broadcast data. Once the packet identifier information is selected, the control unit 100 starts playback of the recorded broadcast data using the acquired packet identifier. In case when no resume marker is detected from the recorded broadcast data, the control unit 100 checks the system time Ti at which the broadcast data recording started.

Once the packet identifier information is determined at step 513 or 507, the control unit 100 starts playback of the broadcast data using the packet identifier information (515).

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

Although exemplary embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

As described above, the broadcast recording and reproducing method and apparatus for the mobile terminal according to the present invention is advantageous to record the broadcast data in which the PMT is acquired at a relatively long interval and minimize the data loss occurring before acquiring the PMT.

What is claimed is:

1. A recorded broadcast data playback method operable in a mobile terminal, comprising:
detecting a playback instruction for playing recorded broadcast data;
determining whether a resume marker exists in the recorded broadcast data;
obtaining, when the resume marker exists, a resume time associated with the resume marker, for determining a playback start time of the recorded broadcast data;
extracting a system time of the recorded broadcast data corresponding to the obtained resume time;
acquiring a plurality of packet identifiers corresponding to the system time;
decoding the recorded broadcast data indicated by the acquired packet identifier; and
displaying said decoded recorded broadcast data.

2. The recorded broadcast data playback method of claim 1, wherein the resume marker defines a time at which the playback of the recorded broadcast data is paused.

3. The recorded broadcast data playback method of claim 1, further comprising:
selecting a recording start time of the broadcast data as a playback start time of the recorded broadcast data, when no resume marker exists,.

4. The recorded broadcast data playback method of claim 1, wherein the resume time is a time associated with said resume marker.

5. The recorded broadcast data playback method of claim 1, wherein the system time is a time at which recording the broadcast data starts or a Program Map Table (PMT) carried by the broadcast data is changed.

6. The recorded broadcast data playback method of claim 1, wherein extracting a system time comprises applying, when a resume marker exists, the resume time to a conditional expression.

7. The recorded broadcast data playback method of claim 6, wherein the conditional expression is
((Time N-1)−Time 1≦resume time<(Time N)−Time 1),
N is a number of PMT backup times during the broadcast data recording,
Time N is the system time for N^{th} PMT backup,
Time N−1 is the system time for (N−1)^{th} PMT backup, and
Time 1 is a system time at which the broadcast recording starts.

8. The recorded broadcast data playback method of claim 7, wherein extracting a system time comprises selecting a system time satisfying the conditional expression and prior to the resume time.

9. A broadcast data recording method operable in a mobile terminal, comprising:
playing broadcast data received in real time;
acquiring Program Map Tables (PMT's) from the broadcast data;
extracting packet identifiers from the PMT's;
starting the recording of the broadcast data in response to a recording instruction input by a user; and
storing the packet identifiers and system times at which the packet identifiers are extracted.

10. The broadcast data recording method of claim 9, wherein the system times are times at which recording the broadcast data starts and the Program Map Table (PMT) is changed.

11. The broadcast data recording method of claim 9, wherein storing the packet identifiers comprising:
extracting, when the PMT is changed while the broadcast data is recorded, packet identifier information from the changed PMT; and
storing the packet identifier information with a system time at which the PMT is changed.

12. A broadcast data recording and reproducing apparatus for a mobile terminal, comprising:
a storage unit which stores packet identifiers extracted from broadcast data and system times; and
a control unit which obtains, when a resume marker exists, a resume time associated with the resume marker in response to a recorded broadcast data playback instruction, extracts a plurality of packet identifiers stored in correspondence with the resume time, and plays the recorded broadcast data using the packet identifiers.

13. The broadcast data recording and reproducing apparatus of claim 12, wherein the control unit acquires, while the broadcast data is played, a Program Map Table (PMT) from the broadcast data, extracts the packet identifiers from the PMT, and starts recording the broadcast data in response to a broadcast data recording instruction.

14. The broadcast data recording and reproducing apparatus of claim 12, the resume marker is associated with a time at which the playback of the recorded broadcast data is paused.

15. The broadcast data recording and reproducing apparatus of claim 12, wherein the control unit determines, when the resume marker is initialized, a start time of recording the broadcast data as a playback start time of the recorded broadcast data.

16. The broadcast data recording and reproducing apparatus of claim 12, wherein the resume time is a time at which the resume marker points.

17. The broadcast data recording and reproducing apparatus of claim 12, wherein the system time is a time at which recording the broadcast data starts or a Program Map Table (PMT) carried by the broadcast data is changed.

18. The broadcast data recording and reproducing apparatus of claim 12, wherein the control unit applies, when a resume marker exists, the resume time to a conditional expression.

19. The broadcast data recording and reproducing apparatus of claim 18, wherein the conditional expression is
((Time N-1)−Time 1≦resume time<(Time N)−Time 1),
where N is a number of PMT backup times during the broadcast data recording,
Time N is the system time for N^{th} PMT backup,
Time N−1 is the system time for (N−1)^{th} PMT backup, and
Time 1 is a system time at which the broadcast recording starts.

20. The broadcast data recording and reproducing apparatus of claim 19, wherein the control unit selects a system time satisfying the conditional expression and prior to the resume time.

21. The broadcast data recording and reproducing apparatus of claim 12, wherein the control unit extracts, when the PMT is changed while the broadcast data is recorded, the packet identifiers from the changed PMT and stores the packet identifiers with the system time at which the PMT is changed.
